(19) United States
(12) Patent Application Publication
(10) Pub. No.: US 2023/0004363 A1
(43) Pub. Date: Jan. 5, 2023

(54) STREAM COMPUTING JOB PROCESSING METHOD, STREAM COMPUTING SYSTEM AND ELECTRONIC DEVICE

(71) Applicant: Beijing Baidu Netcom Science Technology Co., Ltd., Beijing (CN)

(72) Inventor: Youjun Yuan, Beijing (CN)

(73) Assignee: Beijing Baidu Netcom Science Technology Co., Ltd., Beijing (CN)

(21) Appl. No.: 17/784,454

(22) PCT Filed: Jul. 27, 2020
(86) PCT No.: PCT/CN2020/104873

§ 371 Date: Jun. 10, 2022

(30) Foreign Application Priority Data
Jan. 22, 2020 (CN) 202010074558.X

(51) Int. Cl. G06F 8/41; G06F 9/54; G06F 8/30

(52) U.S. Cl. CPC G06F 8/41; G06F 9/54; G06F 8/31

(57) ABSTRACT

This application discloses a stream computing job processing method, a stream computing system and an electronic device, and the method includes: obtaining a stream computing job; running the stream computing job in a process-based manner, where the stream computing job includes at least one process.

### CROSS-REFERENCE TO RELATED APPLICATION

The present application claims a priority to Chinese Patent Application No. 202010074558.X filed in China on Jan. 22, 2020, a disclosure of which is incorporated in its entirety by reference herein.

### TECHNICAL FIELD

The present application relates to the field of data processing technologies, in particular to the field of cloud computing technologies, and specifically to a stream computing job processing method, a stream computing system and an electronic device.

### BACKGROUND

Stream computing refers to real-time processing of continuously generated data streams, and has stronger timeliness than batch—processing-based computing. As Internet technologies continue to evolve, computing resources are usually limited in computing fields represented by edge computing and the like, and more stringent requirements on resource consumption are put forward.

At present, open source stream computing systems represented by Apache Storm/Spark/Flink have been developed considerably. Stream computing jobs are usually processed in parallel in these open source stream computing systems. For example, in a Master/Worker structure, the Master is responsible for accepting, scheduling and monitoring a job, and the Worker is responsible for job execution and status reporting, etc. The Master and the Worker process in parallel, and system resource consumption is high.

As can be seen, the stream computing job processing method in the related art suffers from high resource consumption.

### SUMMARY

Embodiments of the present application provide a stream computing job processing method, a stream computing system and an electronic device, so as to solve the problem of large resource consumption of the stream computing job processing method in the related art.

To solve the above technical problem, the present application is realized as follows.

In a first aspect, an embodiment of the present application provides a stream computing job processing method, and the method includes following steps: obtaining a stream computing job; running the stream computing job in a process-based manner, where the stream computing job includes at least one process.

Due to the use of the above mentioned technical means, the stream computing job is run directly as a process. Compared with the parallel processing approach for stream computing jobs such as the Master/Worker structure in the prior art, this can avoid the problem of large resource consumption in the parallel processing approach, and can greatly reduce the resource consumption of the stream computing system, which is especially suitable for scenarios with limited number of jobs and limited computing capability.

Optionally, prior to obtaining the stream computing job, the method further includes: receiving the stream computing job sent by a cloud server, where the stream computing job is generated by the cloud server.

In the implementation, a generation environment and a running environment of the stream computing job are separated. The cloud server complies the continuously generated stream computing jobs, while the system can directly run compiled stream computing jobs, which improves the efficiency of the system in processing stream computing jobs and reduces system resource consumption at the same time.

Optionally, the running the stream computing job in the process-based manner includes: running the stream computing job in the process-based manner by using a compiled language as an implementation language.

Further, the compiled language includes Golang language.

In the implementation, the compiled language, such as Golang, is used as the implementation language to complete compilation of the stream computing job without relying on other modules or the base environment, thus the stream computing job is processed with high efficiency. Meanwhile executable codes can be produced directly by the compiled language, which reduces unnecessary operations during compilation, thereby further reducing system resource consumption.

Optionally, the stream computing job includes multiple processes; the running the stream computing job in the process-based manner includes: allocating running resources for the different processes of the stream computing job, respectively; running the processes on respective running resources of the multiple processes, where the multiple processes communicate with each other.

Further, the multiple processes communicate with each other based on interprocess communication (IPC).

In the implementation, the multiple processes of the stream computing job run on allocated running resources, respectively, while the multiple processes can communicate with each other. Further, the multiple processes can communicate with each other based on IPC without the need for communication through network transmission, thereby reducing the serialization and deserialization of data objects in network transmission. While multiple processes run independently, the multiple processes can exchange information with each other to jointly complete running of one stream computing job in conjunction, which improves data transmission efficiency, in turn improves the efficiency of stream computing job processing, and meanwhile further reduces consumption of resources such as memory.

In a second aspect, the present application provides a stream computing system, and the stream computing system includes: an obtaining module, configured to obtain a stream computing job; a running module, configured to run the stream computing job in a process-based manner, where the stream computing job includes at least one process.

Optionally, the system further includes: a reception module, configured to receive the stream computing job sent by a cloud server, where the stream computing job is generated by the cloud server.

Optionally, the running module is specifically configured to run the stream computing job in the process-based manner by using a compiled language as an implementation language.

Optionally, the compiled language includes Golang language.

Optionally, the stream computing job includes multiple processes; and the running module includes: an allocation unit, configured to allocate running resources for the different processes of the stream computing job, respectively; a running unit, configured to run the processes on respective running resources of the processes, where the multiple processes communicate with each other.

Optionally, the multiple processes communicate with each other based on interprocess communication (IPC).

In a third aspect, the present application provides an electronic device, and the electronic device includes: at least one processor; and a memory communicatively connected to the at least one processor, where, the memory stores therein an instruction executable by the at least one processor, and the at least one processor is configured to execute the instruction to implement any method in the first aspect.

In a fourth aspect, the present application provides a non-transitory computer readable storage medium storing therein computer instructions, where the computer instructions are used for causing a computer to implement any method in the first aspect.

The embodiment of the present application has the following advantages or beneficial effects. The stream computing job is run directly as a process. Compared with the parallel processing approach for stream computing jobs such as the Master/Worker structure in the prior art, this can avoid the problem of large resource consumption in the parallel processing approach, and can greatly reduce the resource consumption of the stream computing system, which is especially suitable for scenarios with limited number of jobs and limited computing capability.

The advantages or beneficial effects of embodiments of the present application will be described in the following with reference to specific embodiments.

### BRIEF DESCRIPTION OF THE DRAWINGS

The drawings are used to better understand the solutions of the present application and constitute no limitation on the present application. Where,

FIG. 1 is a flowchart of a stream computing job processing method provided in an embodiment of the present application;

FIG. 2 is another flowchart of a stream computing job processing method provided in an embodiment of the present application;

FIG. 3 is a first structural diagram of a stream computing system provided in an embodiment of the present application;

FIG. 4 is a second structural diagram of a stream computing system provided in an embodiment of the present application;

FIG. 5 is a third structural diagram of a stream computing system provided in an embodiment of the present application;

FIG. 6 is a block diagram of an electronic device for implementing a stream computing job processing method of an embodiment of the present application.

### DETAILED DESCRIPTION

In the following description, numerous details of the embodiments of the present application, which should be deemed merely as exemplary, are set forth with reference to accompanying drawings to provide thorough understanding of the embodiments of the present application. Therefore, those skilled in the art will appreciate that modifications and replacements may be made in the described embodiments without departing from the scope and the spirit of the present application. Further, for clarity and conciseness, descriptions of known functions and structures are omitted hereinafter.

Stream data refers to an aggregation of a series of dynamic data infinite in time distribution and quantity. Due to strong timeliness of the data, a computation in real-time must be performed and rapid analysis and response must be performed. The stream computation is real-time processing of continuously generated data stream.

Conventional stream computing job processing usually includes several to several thousand clusters, which provide unified computing resources for thousands of jobs and adopt parallel processing approach such as Master/Worker structure. The Master manages and schedules resources and jobs uniformly, and when the Master receives a request from a user for starting a stream computing task, the Master divides the stream computing task into multiple jobs and assigns them to different Workers for execution, and the Workers compile the received jobs before execution. A management mode such as Master/Worker structure entails high management cost, and the parallel processing approach thereof brings about large fixed resource consumption, which is especially uneconomical for computing scenarios with limited number of jobs and limited computing resources.

According to an embodiment of the present application, the present application provides a stream computing job processing method.

Referring to FIG. 1, FIG. 1 is a flowchart of a stream computing job processing method provided in an embodiment of the present application, and the method is applicable to a stream computing system. The stream computing system may be a computer, a server, or other device or data platform having data processing functions, which is not limited herein.

In an embodiment of the present application, the stream computing job processing method includes Step 101 and Step 102.

Step 101, obtaining a stream computing job.

When the stream computing system needs to run a stream computing task, a stream computing job is obtained firstly. One stream computing job in the embodiment of the present application may correspond to one executable file generated by compilation, which includes one stream computing job logic. The stream computing job logic includes programs of the stream computing job, a data set, and specification for running the stream computing job, and after obtaining the executable file the system can run it according to the job logic.

Step 102, running the stream computing job in a process-based manner, where the stream computing job includes at least one process.

In the embodiment of the present application, the stream computing job includes at least one process. When the system receives the stream computing job, the system can run a corresponding process directly according to a process list of the stream computing job. Specifically, one stream computing job may include one or more processes, stream data continuously input to the system may trigger a corresponding process to start execution of corresponding programs, and then output computing results continuously. Once the data stream triggers a stream computing job, the job can be run immediately and the computing results can be output.

The embodiment of the present application has the following advantages or beneficial effects. The stream computing job is run directly in a process-based manner. Compared with the parallel processing approach for stream computing jobs such as the Master/Worker structure in the prior art, this can avoid the problem of large resource consumption in the parallel processing approach, and can greatly reduce the resource consumption of the stream computing system, which is especially suitable for scenarios with limited number of jobs and limited computing capability such as edge computing.

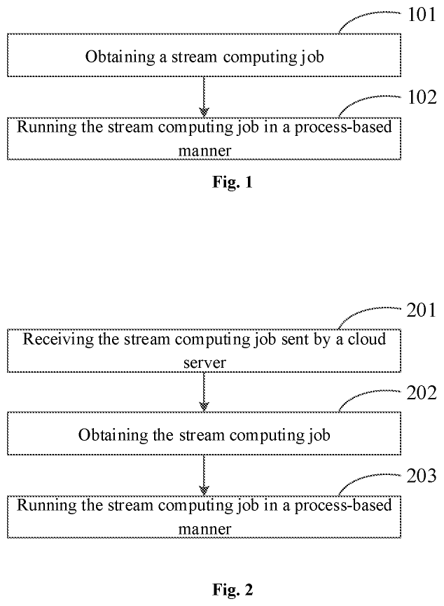

Referring to FIG. 2, FIG. 2 is another flowchart of a stream computing job processing method provided in an embodiment of the present application, and the method is applied to a stream computing system. The stream computing system may be a computer, a server, or other device or data platform having data processing functions, which is not limited herein.

In the embodiment of the present application, the stream computing job processing method includes Step 201 to Step 203.

Step 201, receiving the stream computing job sent by a cloud server, where the stream computing job is generated by the cloud server.

After receiving a stream computing request from a user, the stream computing system needs to compile the stream computing job into executable machine codes. In conventional stream computing job processing methods, the procedure is carried out within the system, i.e., both the generation and running of stream computing job are implemented within the stream computing system. But for some stream computing jobs that consume more resources, compilation thereof will causes large resource consumption.

In the embodiment of the present application, the stream computing jobs are generated by a cloud server, thus generation environment and running environment of the stream computing jobs are separated. In the cloud server, the stream computing job is compiled into executable machine codes to generate a corresponding executable file, and then the executable file is directly deployed to a target stream computing system for running. When the system obtains the stream computing job, the stream computing job can be run directly based on the compiled executable file. During the course, the cloud server complies the continuously generated stream computing jobs, while the system only runs the continuously received stream computing jobs directly in a process-based manner, which improves the efficiency of stream computing job processing and reduces system resource consumption at the same time.

Step 202, obtaining the stream computing job.

In the embodiment of the present application, the compilation of the streaming computing job has been completed at the cloud server, and the system only needs to obtain the compiled stream computing job. One complied stream computing job may correspond to one executable file, which includes one stream computing job logic. The stream computing job logic includes programs of the stream computing job, a data set, and specification for the stream computing job, and the system can start to run stream computing jobs once triggered by the data stream.

Step 203, running the stream computing job in a process-based manner, where the stream computing job includes at least one process.

For a specific implementation of this step, reference can be made to the description of Step 102 in the embodiment shown in FIG. 1 and a repeated description is omitted here.

Optionally, Step 203 includes: running the stream computing job in the process-based manner by using a compiled language as an implementation language.

Further, the compiled language includes Golang language.

Java is used as the implementation language in conventional stream computing job processing methods. Java is an interpreted language and relies on JVM (Java Virtual Machine) to run. Real-time compilation and execution of Java programs are performed by the JVM, which means that the JVM needs to be pre-installed in the stream computing system. Loading the entire JVM into the memory occupies significant memory resources. In addition, since Java is an interpreted language, during compilation, source codes cannot be directly translated into machine language, and needs to be translated into intermediate codes firstly; and then the intermediate codes are interpreted and run by an interpreter, which also increases the system resource consumption.

In embodiments of the present application, the compiled language is taken as the implementation language, the stream computing job is run in the process-based manner, and the compiled language may include Golang language. Golang, abbreviated as Go, is a lightweight compiled language. Compiled languages such as Golang can compile the programs that need to be executed in the stream computing job directly into an executable file, and do not depend on an underlying environment such as JVM. The stream computing job can be run directly based on the executable file.

It should be noted that, other lightweight compiled languages such as C or C++ can also be used in embodiments of the present application, without any limitation here.

The above embodiment of the present application has the following advantages or beneficial effects: the compiled language is used as the implementation language to run the stream computing job in a process-based manner, so that the stream computing job is directly compiled into an executable file without relying on modules such as JVM or a underlying environment, and stream computing jobs are processed with high efficiency. Meanwhile, since the compiled language generates executable codes, unnecessary operations during compilation when using interpreted languages are reduced, thereby further reducing resource consumption such as memory.

It should be noted that, the technical solutions in the embodiments of the present application are also applicable to the embodiment as shown in FIG. 1 and can achieve the same beneficial effect, a repeated description is omitted here.

Optionally, the stream computing job includes multiple processes; Step 203 includes: allocating running resources for the different processes of the stream computing job, respectively; running the processes on the respective running resources of the processes, where the multiple processes communicate with each other.

The stream computing job may include only one process or may include multiple processes, and each of processes may include multiple threads of program execution. The system may allocate corresponding running resources for each process, the running resources include an address space corresponding to each process, where the address space represents a size of memory which can be occupied by the process while the process is running, and the address space includes a physical space and a virtual space. Each process runs on corresponding running resources, and the processes run independent of each other. In a case that one stream computing job includes multiple processes, when running the stream computing job, the multiple processes need to cooperate with each other and perform data communication and resource sharing, to jointly complete the stream computing job.

Further, the multiple processes communicate with each other based on interprocess communication (IPC).

In conventional stream computing frameworks, data transfer is achieved through network transmission between operators of different processes. In network transmission, in order to ensure integrity and transferability of data, a data object needs to be serialized and converted into a byte sequence at a sender firstly; and when the serialized byte stream is transmitted to a receiver, the receiver reconstructs the object by deserialization of the byte stream. Thus, transmission efficiency is low and the resource consumption is increased during the serialization and deserialization.

In the embodiment of the present application, the stream computing job is run in a process-based manner, and communication between the processes can be guaranteed based on IPC (interprocess communication). IPC is a set of programming interfaces that can coordinate operation of different processes, so that the multiple processes of the stream computing job can run independently of each other while passing and exchanging information with each other, so as to coordinate operation of a single stream computing job. IPC includes features such as pipelines, message queues, shared memory, and semaphores, and can achieve data sharing between the multiple processes of the stream computing job as well as data transmission, notification time, resource sharing, and process control. IPC eliminates the need for network transmission of the data object, reduces serialization and deserialization of data objects, and improves the efficiency of data transmission between the multiple processes of the stream computing job, while further reducing resource consumption.

Specifically, the multiple processes can communicate with each other by sharing memory, and pass data objects directly in the memory. The multiple processes of the stream computing job have address spaces that are independent of each other, but the multiple processes can access a shared memory zone at the same time. Each process has its own process control block, address space and one page table corresponding to the address space, and the page table is responsible for mapping a virtual address of the current process to a physical address. When the multiple processes map a virtual address to a physical address through a page table, there is a shared memory zone in the physical address space, and the multiple processes can access the shared memory zone. In this way, when any process writes data to the shared memory zone, data changes caused by the data written by the process are instantly known to other processes that share memory with the process, and the other processes can read the data.

It should be noted that, in the embodiment of the present application, communication between the multiple processes of the stream computing job may also be achieved through other IPC features other than the shared memory, or communication can be implemented by utilizing more than two IPC features in conjunction, which is not limited here.

It should be noted that, in the embodiment of the present application, multiple processes run on respective running resources, and communication between the multiple processes based on IPC is coordinated with each other, and there is no precedence order in terms of execution.

The embodiment of the present application has the following advantages or beneficial effects: multiple processes of a stream computing job run on allocated respective running resources, while the multiple processes can communicate with each other. Further, the multiple processes can communicate with each other based on IPC, without the need for communication through network transmission, thus the serialization and deserialization of data objects during network transmission are reduced. While multiple processes run independently, the multiple processes can pass and exchange information with each other to jointly coordinate running of one stream computing job, which improves data transmission efficiency, in turn improves the efficiency of stream computing job processing, and while further reduces resource consumption such as memory.

It should be noted that, the technical solutions in the embodiments of the present application are also applicable to the embodiment as shown in FIG. 1 and can achieve the same beneficial effect, which will not be repeated here to avoid repetition.

The stream computing job processing method provided in the embodiment of the present disclosure adds a number of optional implementations to the embodiment shown in FIG. 1, which can further reduce resource consumption.

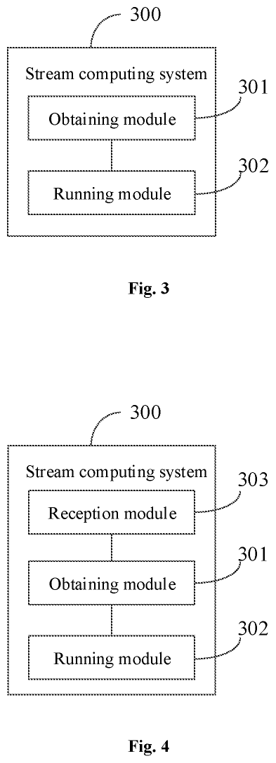

The present application further provides a stream computing system. As shown in FIG. 3, the stream computing system 300 includes: an obtaining module 301, configured to obtain a stream computing job; a running module 302, configured to run the stream computing job in a process-based manner, where the stream computing job includes at least one process.

Optionally, as shown in FIG. 4, the stream computing system 300 further includes: a reception module 303, configured to receive the stream computing job sent by a cloud server, where the stream computing job is generated by the cloud server.

Optionally, the running module 302 is specifically configured to run the stream computing job in the process-based manner by using a compiled language as an implementation language.

Optionally, the compiled language includes Golang language.

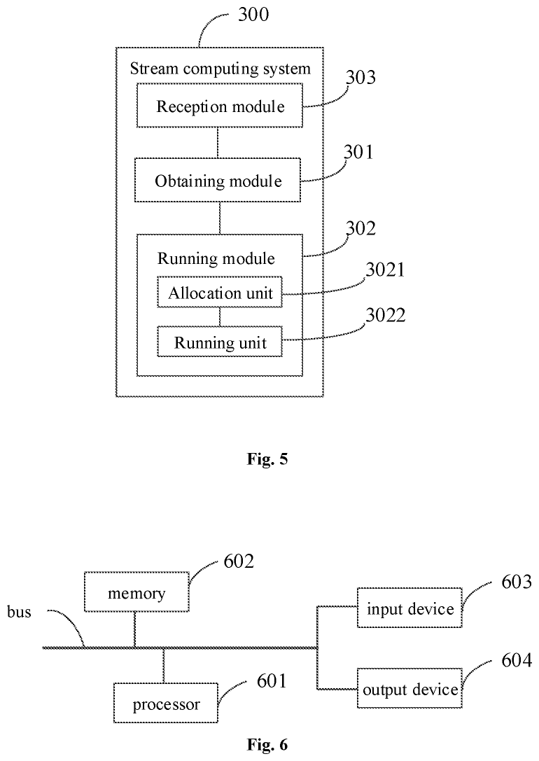

Optionally, the stream computing job includes multiple processes; as shown in FIG. 5, the running module 302 includes: an allocation unit 3021, configured to allocate running resources for the different processes of the stream computing job, respectively; a running unit 3022, configured to run the processes on respective running resources of the processes, where the multiple processes communicate with each other.

Optionally, the multiple processes communicate with each other based on interprocess communication (IPC).

In the embodiment of the present application, the stream computing system 300 is capable of implementing various processes implemented in the method embodiments shown in FIG. 1 and FIG. 2, and achieves the same beneficial effects. To avoid repetition, details are not described herein again.

According to embodiments of the present application, an electronic device and a readable storage medium are further provided.

As shown in FIG. 6, a block diagram of an electronic device for implementing a stream computing job processing method according to an embodiment of the present application is illustrated. The electronic device is intended to represent all kinds of digital computers, such as a laptop computer, a desktop computer, a work station, a personal digital assistant, a server, a blade server, a main frame or other suitable computers. The electronic device may also represent all kinds of mobile devices, such as a personal digital assistant, a cell phone, a smart phone, a wearable device and other similar computing devices. The components shown here, their connections and relationships, and their functions, are meant to be exemplary only, and are not meant to limit implementations of the present application described and/or claimed herein.

As shown in FIG. 6, the electronic device includes: one or more processors 601, a memory 602, and interfaces for connecting various components, including a high-speed interface and a low-speed interface. The various components are interconnected using different buses and may be mounted on a common motherboard or mounted in another manner as desired. The processors may process instructions configured to be executed in the electronic device, and the instructions include instructions stored in the memory or on the memory to display graphical information of GUI on an external input/output device (such as a display device coupled to the interface). In other embodiments, multiple processors and/or multiple buses may be used with multiple memories, if necessary. Also, multiple electronic devices may be connected, and each electronic device provides some of the necessary operations (e.g., in a server array, a group of blade servers, or a multi-processor system). FIG. 6 illustrates a single processor 601 as an example.

The memory 602 is a non-transitory computer-readable storage medium provided herein. The memory stores therein instructions executable by at least one processor to cause the at least one processor to implement the stream computing job processing method according to the present application. The non-transitory computer-readable storage medium of the present application stores therein computer instructions for causing a computer to implement the stream computing job processing method according to the present application.

The memory 602, as a non-transitory computer-readable storage medium, may be used to store non-transitory software programs, non-transitory computer-executable programs, and modules, such as program instructions/modules (e.g., the obtaining module 301 and the running module 302 shown in FIG. 3) corresponding to the stream computing job processing method in the embodiments of the present application. By executing the non-transitory software programs, instructions and modules stored in the memory 602, the processor 601 performs various functional applications and data processing of the server, i.e., implements the stream computing job processing method in the method embodiment described above.

The memory 602 may include a program storage area and a data storage area, where the program storage area may store an operating system, and an application program required for at least one function; and the data storage area may store data created according to the usage of the electronic device for implementing the stream computing job processing method. In addition, the memory 602 may include a high speed random access memory, and may also include a non-transitory memory, such as at least one magnetic disk storage device, flash memory device, or other non-transitory solid state storage device. In some embodiments, the memory 602 may optionally include a memory remotely located with respect to the processor 601. These remote memories may be connected via a network to the stream computing system. Examples of the network mentioned above include, but are not limited to, the Internet, an intranet, a local area network, a mobile communication network, and a combination thereof.

The electronic device for implementing the stream computing job processing method may further include: an input device 603 and an output device 604. The processor 601, the memory 602, the input device 603, and the output device 604 may be connected to each other via a bus or in other ways. In FIG. 6, a connection by a bus is taken as an example.

The input device 603 may receive inputted numeric or character information and generate key signal inputs related to user settings and functional controls of the electronic device for implementing the stream computing job processing method. For example, the input device may include a touch screen, a keypad, a mouse, a trackpad, a touch pad, a pointing stick, one or more mouse buttons, a trackball, a joystick, etc. The output device 604 may include a display device, an auxiliary lighting device (e.g., LED), a tactile feedback device (e.g., a vibration motor), etc. The display device may include, but is not limited to, a liquid crystal display (LCD), a light emitting diode (LED) display, and a plasma display. In some embodiments, the display device may be a touch screen.

Various embodiments of the systems and techniques described herein can be implemented in a digital electronic circuit system, an integrated circuit system, an ASIC (application specific integrated circuit), computer hardware, firmware, software, and/or combinations thereof. These various implementations may include implementation in one or more computer programs that may be executed and/or interpreted on a programmable system including at least one programmable processor. The programmable processor may be a dedicated or general purpose programmable processor, and may receive data and instructions from a storage system, at least one input device and at least one output device, and transmit data and instructions to the storage system, the at least one input device and the at least one output device.

These computing programs (also referred to as programs, software, software applications, or codes) include machine instructions for a programmable processor, and may be implemented using high-level procedural and/or object-oriented programming languages, and/or assembly/machine languages. As used herein, the terms “machine-readable medium” and “computer-readable medium” refer to any computer program product, apparatus, and/or device (e.g., magnetic disk, optical disc, memory, programmable logic device (PLD)) for providing machine instructions and/or data to a programmable processor, including a machine-readable medium that receives machine instructions implemented as machine-readable signals. The term “machine-readable signal” refers to any signal used to provide machine instructions and/or data to a programmable processor.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN) and the Internet.

The computer system can include a client and a server. The client and server are generally remote from each other and typically interact through a communication network. The relationship of client and server arises by virtue of computer programs running on respective computers and having a client-server relationship with each other.

According to technical solutions of embodiments of the present application, a stream computing job is obtained; the stream computing job is run in a process-based manner, where the stream computing job includes at least one process. The stream computing job is run directly as a process. Compared with the parallel processing approach for stream computing jobs such as the Master/Worker structure in the prior art, this can avoid the problem of large resource consumption in the parallel processing approach, and can greatly reduce the resource consumption of the stream computing system, which is especially suitable for scenarios with limited number of jobs and limited computing capability.

It is appreciated, all forms of processes shown above may be used, and steps thereof may be reordered, added or deleted. For example, as long as expected results of the technical solutions of the present application can be achieved, steps set forth in the present application may be performed in parallel, performed sequentially, or performed in a different order, and there is no limitation in this regard.

The foregoing specific implementations constitute no limitation on the scope of the present application. It is appreciated by those skilled in the art, various modifications, combinations, sub-combinations and replacements may be made according to design requirements and other factors. Any modifications, equivalent replacements and improvements made without deviating from the spirit and principle of the present application shall be deemed as falling within the scope of the present application.

1. A stream computing job processing method, comprising:
obtaining a stream computing job;
running the stream computing job in a process-based manner, wherein the stream computing job comprises at least one process.

2. The stream computing job processing method according to claim 1, wherein, prior to obtaining the stream computing job, the method further comprises:
receiving the stream computing job sent by a cloud server, wherein the stream computing job is generated by the cloud server.

3. The stream computing job processing method according to claim 1, wherein the running the stream computing job in the process-based manner comprises:
running the stream computing job in the process-based manner by using a compiled language as an implementation language.

4. The stream computing job processing method according to claim 3, wherein the compiled language comprises Golang language.

5. The stream computing job processing method according to claim 1, wherein the stream computing job comprises multiple processes;
the running the stream computing job in the process-based manner comprises:
allocating running resources for the processes of the stream computing job, respectively;
running the processes on respective running resources of the processes, wherein the multiple processes communicate with each other.

6. The stream computing job processing method according to claim 5, wherein the multiple processes communicate with each other based on interprocess communication (IPC).

7.-12. (canceled)

13. An electronic device, comprising:
at least one processor; and
a memory communicatively connected to the at least one processor, wherein,
the memory stores therein an instruction executable by the at least one processor, and the at least one processor is configured to execute the instruction to implement a stream computing job processing method comprising:
obtaining a stream computing job;
running the stream computing job in a process-based manner, wherein the stream computing job comprises at least one process.

14. A non-transitory computer readable storage medium storing therein a computer instruction, wherein the computer instruction is configured to be executed by a computer, to implement a stream computing job processing method comprising:
obtaining a stream computing job;
running the stream computing job in a process-based manner, wherein the stream computing job comprises at least one process.

15. The electronic device according to claim 13, wherein, prior to obtaining the stream computing job, the method further comprises:
receiving the stream computing job sent by a cloud server, wherein the stream computing job is generated by the cloud server.

16. The electronic device according to claim 13, wherein the running the stream computing job in the process-based manner comprises:
running the stream computing job in the process-based manner by using a compiled language as an implementation language.

17. The electronic device according to claim 16, wherein the compiled language comprises Golang language.

18. The electronic device according to claim 13, wherein the stream computing job comprises multiple processes;
the running the stream computing job in the process-based manner comprises:
allocating running resources for the processes of the stream computing job, respectively;
running the processes on respective running resources of the processes, wherein the multiple processes communicate with each other.

19. The electronic device according to claim 18, wherein the multiple processes communicate with each other based on interprocess communication (IPC).

20. The non-transitory computer readable storage medium according to claim 14, wherein, prior to obtaining the stream computing job, the method further comprises:
receiving the stream computing job sent by a cloud server, wherein the stream computing job is generated by the cloud server.

21. The non-transitory computer readable storage medium according to claim 14, wherein the running the stream computing job in the process-based manner comprises:
running the stream computing job in the process-based manner by using a compiled language as an implementation language.

22. The non-transitory computer readable storage medium according to claim 21, wherein the compiled language comprises Golang language.

23. The non-transitory computer readable storage medium according to claim 14, wherein the stream computing job comprises multiple processes;
the running the stream computing job in the process-based manner comprises:
allocating running resources for the processes of the stream computing job, respectively;
running the processes on respective running resources of the processes, wherein the multiple processes communicate with each other.

24. The non-transitory computer readable storage medium according to claim 23, wherein the multiple processes communicate with each other based on interprocess communication (IPC).
